(19) United States
(12) Patent Application Publication
(10) Pub. No.: US 2016/0076984 A1
(43) Pub. Date: Mar. 17, 2016

(54) SHEARING DEVICE FOR STRENGTH TESTING A JOINT

(71) Applicant: Airbus Operations GmbH, Hamburg (DE)

(72) Inventors: Hans-Juergen NICK, Hamburg (DE); Hans MARQUARDT, Hamburg (DE); Rene KRAUSE, Hamburg (DE)

(21) Appl. No.: 14/854,712

(22) Filed: Sep. 15, 2015

(30) Foreign Application Priority Data
Sep. 17, 2014 (DE) 10 2014 113 428.1

(51) Int. Cl. G01N 3/24

(52) U.S. Cl. CPC G01N 3/24

(57) ABSTRACT

A shearing device for strength testing a joint is provided and a method for the preparation of a shearing device for strength testing a joint. The joint may consist of an adhesive joint. The shearing device comprises a first component, a second component, a fastening arrangement and an adjusting device. The first component comprises a first receptacle, and the second component comprises a second receptacle. The fastening arrangement is designed for fastening the first component and the second component on one another in such a way that the first receptacle and the second receptacle face one another and a shear plane S is formed between the first component and the second component. The adjusting device is designed for arranging a joint of a specimen to be tested in the shear plane S.

### CROSS-REFERENCE TO RELATED APPLICATION

This application claims priority German Patent Application No. DE 10 2014 113 428.1, filed 17 Sep. 2014, which is incorporated herein by reference in its entirety.

### TECHNICAL FIELD

The embodiments pertain to a shearing device for strength testing a joint and to a method for the preparation of a shearing device for strength testing a joint.

### BACKGROUND

Strength tests and shear tests of a joint, particularly an adhesive joint, are usually carried out based on standard AITM1-0019. For this purpose, a specimen consisting of two individual parts, which that are connected to one another in an overlapping fashion, is mounted in a tension mechanism in such a way that two projecting ends of the specimen can be respectively connected to a tensioning jaw of the tension mechanism. Subsequently, the specimen is pulled apart along the joint, usually until failure of the joint occurs.

Standard AITM1-0019 specifies a specimen size of approximately 250×25 mm for tests of this type. Similar values are specified in standards DIN 14869-2 or DVS 2203-6. If specimens with such an edge length are removed from a component, this component is in most cases destroyed beyond repair or at least requires very elaborate repair work.

It would therefore be desirable to provide a shearing device for the strength testing a joint, by means of which a specimen can be obtained with far less damage to the component.

In addition, other objects, desirable features and characteristics will become apparent from the subsequent summary and detailed description, and the appended claims, taken in conjunction with the accompanying drawings and this background.

### SUMMARY

An objective of the embodiments is to provide a shearing device for strength testing a joint, as well as a method for the preparation of a shearing device for strength testing a joint, that makes it possible to obtain a specimen with only little damage to the component.

This objective is achieved by means of a shearing device for the strength testing a joint and by means of a method for the preparation of a shearing device for the strength testing a joint. Advantageous embodiments and enhancements are disclosed in the claims herein and the following description.

It is proposed to make available a shearing device for the strength testing a joint. The joint may consist of any permanent connection between at least two components such as, e.g., an adhesive joint, a cured joint, a welded joint or a soldered joint. The joint forms part of the specimen to be tested. The specimen or the two interconnected sections of the components respectively may consist of plastic materials, ceramic materials, composite materials or metallic materials. They preferably consist of carbon fiber reinforced plastics, glass fiber reinforced plastics, and aramid fiber reinforced plastics.

The shearing device comprises a first component, a second component, a fastening arrangement, and an adjusting device. The first component comprises a first receptacle. The second component comprises a second receptacle. The fastening arrangement is designed for fastening the first component and the second component on one another in such a way that the first receptacle and the second receptacle face one another and a shear plane is formed between the first component and the second component. The adjusting device is designed for arranging a joint of a specimen to be tested in the shear plane.

The design of this shearing device makes it possible to test specimens that are smaller than the specimen size of approximately 250×25 mm specified in standard AITM1-0019. For example, the specimens may have a diameter or a width of 3 to 5 mm. Such specimens can be (depending on the respective material) very easily drilled, sawn or punched out of the component. The thusly created holes in the component furthermore can be easily repaired (e.g. with a repair rivet) and do not destroy wide areas or the entire component. In this way, significant cost savings can be achieved.

In addition, the embodiments also make it possible to test specimens consisting of very small components or of components, the properties of which to be tested locally fluctuate significantly, as well as specimens with very small or narrow joints or sections of the components that are difficult to access. In this way, shear tests can also be carried out in situations that until now were hardly possible or not possible at all.

In one embodiment, the first and/or the second receptacle comprises a round recess for inserting a cylindrical specimen. Such cylindrical specimens can be easily produced, e.g., by means of hollow drills. The recess may consist of one through-hole in both components or of a combination of a through-hole in one component and a blind hole in the other component. The recesses of the first and the second receptacle may have the same size and, in particular, the same diameter.

The first and/or the second receptacle may also comprise an angular recess for inserting a square or cuboid specimen. Such square or cuboid specimens can be easily produced, e.g., by means of punching or sawing.

In one embodiment, the recess has a diameter or a width between 1 and 10 mm, preferably between 2 and 7 mm, particularly between 3 and 5 mm. The first and/or the second receptacle may be designed for inserting a specimen to be tested with a cross-sectional area between 1 and 100 mm², preferably between 5 and 50 mm², particularly between 10 and 25 mm².

In another embodiment, the second and/or the first receptacle comprises a hollow space for inserting a specimen holder. The hollow space may consist of a round or angular milled cavity. The specimen holder may consist of a plate or a disk with a round or angular recess for inserting the specimen. The specimen may be glued into the recess of the specimen holder in order to ensure that it is securely fixed during the shear test. In this way, particularly short specimens can also be tested.

In one embodiment, the second component comprises a cutout for receiving the first component. The cutout may consist of a milled recess, wherein the milled recess may be U-shaped. In one embodiment, the second component is block-shaped and the first component is step-shaped with a flat part and a thicker part. The thicker part may be designed for being fitted or inserted into the cutout of the second component.

Centering of the two components relative to one another may be realized by means of the specimen and/or by guiding the first component on at least one side of the respective cutout or milled recess in the second component. Centering may also be realized by means of a centering aid such as, e.g., a centering pin.

In one embodiment, the fastening arrangement comprises at least two web-shaped strips and corresponding fastening means for connecting the strips to the second component. The fastening arrangement therefore serves for securing the one component from falling out and/or for guiding the component relative to the other component. The fastening arrangement may consist of one or more screws, clips, clamps, quick-action tensioners, bayonet fixtures or the like.

In one embodiment, the adjusting device comprises at least one screw for adjusting the position of the joint to be tested in the first receptacle and/or the second receptacle. In this context, the term “screw” should be interpreted as a generic term for all functionally or constructively similar adjusting devices. In one embodiment, the adjusting device comprises additionally or alternatively to the screw at least one shimming means for adjusting the position of the joint to be tested in the first receptacle and/or the second receptacle. The adjusting device makes it possible to displace the specimens relative to their receptacle in order to position the joint of the respective specimen exactly on the shear plane of the two components. In this way, a precision adjustment of the specimen position can be realized, e.g., for variable specimen lengths.

The shearing device may additionally comprise a third component that is designed for being at least partially fitted into the cutout of the second component together with the first component and for pressing together the first and the second component in cooperation with the fastening arrangement. As a basic rule, individual parts of the shearing device mentioned herein may be arbitrarily composed of subsystems or individual parts mentioned herein may be combined into superordinate combination parts.

In addition, the shearing device may respectively comprise a connecting piece on the first and the second component in order to produce connections with two tensioning elements of a tension device.

All parts of the shearing device may be made of metal, preferably steel, particularly structural steel. The specimen holders may also be made of the same material as the specimens, e.g. of CFRP. With respect to the dimensions, for example, the first and second components may have a length (in the tensioning direction) between 5 and 20 cm. The first component may have a width between 1 and 5 cm and the second component may have a width between 2 and 10 cm. The width of the first component may be greater than its height. The connecting pieces of both components may amount to less than half the overall length of the respective component.

The embodiment also pertains to a tensioning arrangement for the strength testing a joint. The tensioning arrangement comprises a tension device and the above-described shearing device. The tension device is designed for pulling apart the shearing device in its longitudinal direction.

The embodiment furthermore pertains to a method for the preparation of a shearing device for the strength testing a joint. The method comprises the following steps, which are not necessarily carried out in this sequence: introducing a specimen with a joint to be tested into a first receptacle or into a second receptacle, fastening a first component with the first receptacle on a second component of the second receptacle such that the first receptacle and the second receptacle face one another and a shear plane is formed between the first component and the second component, and arranging the joint of the specimen in the shear plane.

In one embodiment, the step of introducing the specimen comprises the arrangement of the joint of the specimen in the first, e.g., strip-shaped component. This may be followed by respectively separating or removing a fastening arrangement on the second, e.g., block-shaped component and the introduction of the first component with the specimen and, if applicable, a specimen holder into a respective cutout or milled recess of the second component. The second component may likewise comprise a specimen holder. Subsequently, the first component can be respectively fastened on the second component or inserted therein such that the first receptacle and the second receptacle face one another and a shear plane is formed between the first component and the second component. The first and the second component can then be connected to one another by means of the fastening arrangement. Subsequently, the shearing device can be mounted in a standard tension testing machine, e.g., with cardanic mounting. The shear test can now be carried out.

### BRIEF DESCRIPTION OF THE DRAWINGS

The various embodiments will hereinafter be described in conjunction with the following drawing figures, wherein like numerals denote like elements, and:

Other characteristics, advantages and potential applications of the present embodiments result from the following description of the exemplary embodiments and the figures. In this respect, all described and/or graphically illustrated characteristics also form the object of the embodiments individually and in arbitrary combination regardless of their composition in the individual claims or their references to other claims. In the figures, identical or similar objects are identified by the same reference symbols.

FIG. 1 shows schematic views of a shearing device for the strength testing a joint according to an embodiment.

FIG. 2A shows a schematic view of the shearing device; and

FIG. 2B shows schematic views of a first component of the shearing device according to another embodiment.

FIG. 3A shows a schematic view of the shearing device; and

FIG. 3B shows schematic views of the first component of the shearing device according to another embodiment.

FIG. 4A shows a schematic view of the shearing device; and

FIG. 4B shows schematic views of the first component of the shearing device according to another embodiment.

### DETAILED DESCRIPTION

The following detailed description is merely exemplary in nature and is not intended to limit the disclosed embodiments or the application and uses thereof Furthermore, there is no intention to be bound by any theory presented in the preceding background detailed description.

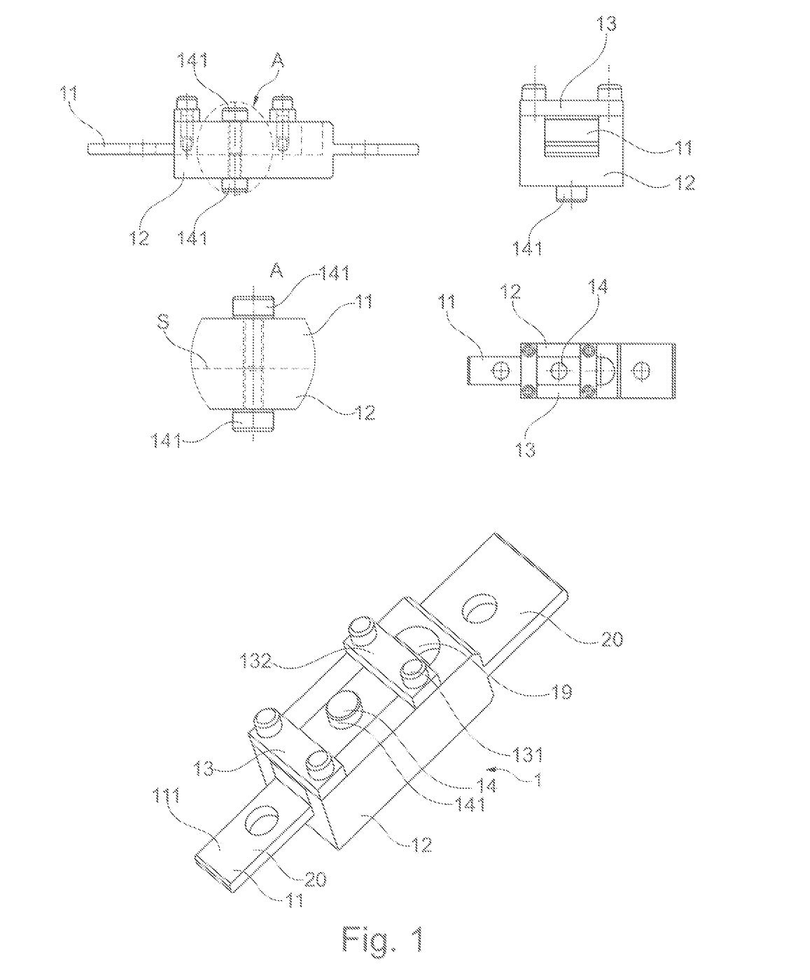

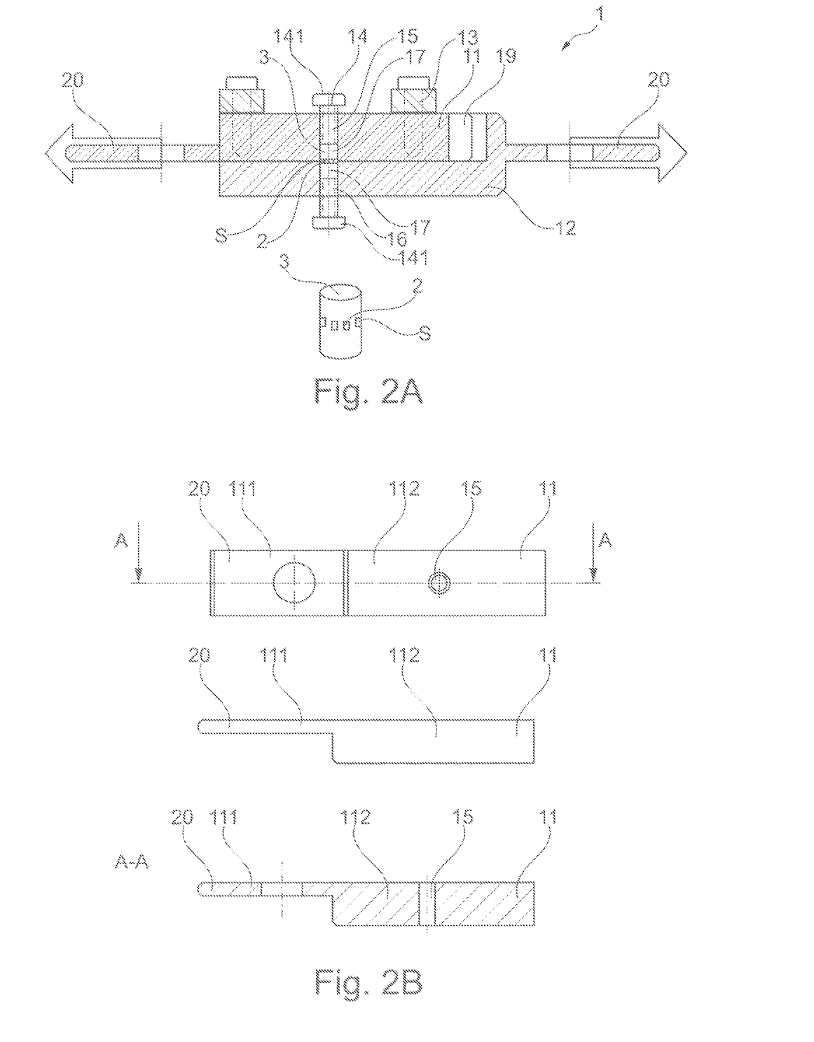

FIG. 1 shows schematic views of a shearing device 1 for strength testing a joint 2 (shown in FIG. 2A) according to an embodiment. The shearing device 1 comprises a first component 11, a second component 12, a fastening arrangement 13, and an adjusting device 14. The second component 12 comprises a cutout 19 for receiving the first component 11. In this case, the cutout 19 is realized in the form of an elongate milled recess ending in a U-shaped fashion. The second component 12 is blocked-shaped, and the first component 11 is step-shaped with a flat part 111 and a thicker part 112 (shown in FIG. 2B). In this case, the thicker part 112 is respectively fitted or inserted into the cutout 19 of the block-shaped second component 12.

The first component 11 comprises a first receptacle 15 (shown in FIGS. 2A and 2B). The second component 12 comprises a second receptacle 16 (shown in FIG. 2A). In FIG. 1, the two receptacles lie in the interior of the shearing device 1.

The fastening arrangement 13 fastens the first component 11 and the second component 12 on one another in such a way that the first receptacle 15 and the second receptacle 16 face one another and a shear plane S is formed between the first component 11 and the second component 12. The adjusting device 14 is designed for arranging a joint 2 of a specimen 3 (shown in FIG. 2A) to be tested in the shear plane S. In this case, the fastening arrangement 13 comprises two web-shaped strips 132 and fastening means in the form of four screws 131 for connecting the strips 132 to the block-shaped second component 12. The fastening arrangement 13 therefore serves for securing the one component from falling out and/or for guiding the component relative to the other component. Instead of the screws 131, the fastening arrangement 13 may also consist of a clamping fixture, clips, quick-action tensioners, bayonet fixtures and/or the like.

In this case, the adjusting device 14 comprises two screws 141 for adjusting the position of the joint 2 to be tested in the first receptacle 15 and the second receptacle 16. The adjusting device 14 makes it possible to displace the specimen 3 relative to its receptacles 15, 16 in order to position the joint 2 of the specimen 3 exactly on the shear plane S of the two components. In this way, a precision adjustment of the specimen position can be realized, e.g., for variable specimen lengths.

In addition, the shearing device 1 respectively comprises a connecting piece 20 on the first component 11 and on the second component 12 in order to produce connections with two tensioning elements (not-shown) of a tension device.

FIG. 2A shows a schematic view of the shearing device 1, and FIG. 2B shows schematic views of the first component 11 of the shearing device 1 according to a further embodiment. The shearing device 1 comprises the first component 11, the second component 12, the fastening arrangement 13, and the adjusting device 14. The first component 11 is inserted into the cutout 19 of the block-shaped second component 12. The first component 11 is step-shaped (see, in particular, FIG. 2B) with a flat part 111 and a thicker part 112 (that is not visible in this figure because it is inserted into the cutout 19 of the block-shaped second component 12).

The first component 11 comprises the first receptacle 15 (see, in particular, FIG. 2B), and the second component 12 comprises the second receptacle 16. The two receptacles 15, 16 respectively comprise a round recess 17 for inserting a cylindrical specimen 3. The recesses 17 consist of through-holes of identical size. In this case, each recess 17 has a diameter between 3 and 5 mm.

The adjusting device 14 in this case comprises two screws 141 for adjusting the position of the joint 2 to be tested in the first receptacle 15 and in the second receptacle 16. The adjusting device 14 makes it possible to displace the specimen 3 relative to its receptacle 14, 15 in order to position the joint 2 of the specimen 3 exactly on the shear plane S of the two components 11, 12. In this way, a precision adjustment of the specimen position can be realized, e.g., for variable specimen lengths.

In addition, the shearing device 1 respectively comprises a connecting piece 20 on the first component 11 and on the second component 12 in order to produce connections with two tensioning elements (not-shown) of a tension device. The tension device is designed for pulling apart the shearing device 1 in its longitudinal direction as indicated by the arrows.

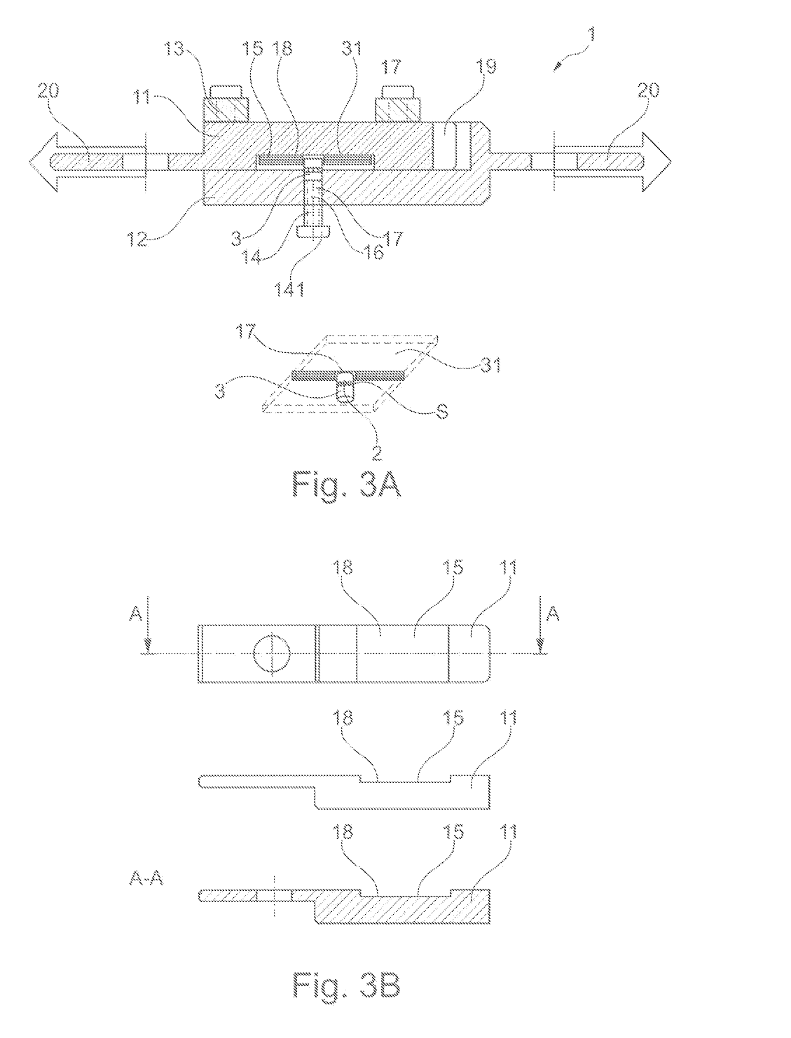

FIG. 3A is a schematic view of the shearing device 1, and FIG. 3B shows schematic views of the first component 11 of the shearing device 1 according to another embodiment. The shearing device 1 once again comprises the first component 11, the second component 12, the fastening arrangement 13, and the adjusting device 14.

The strip-shaped and step-shaped first component 11 is illustrated in detail in FIG. 3B. The first component 11 comprises the first receptacle 15, and the second component 12 comprises the second receptacle 16. The first receptacle 15 comprises a hollow space 18 (see, in particular, FIG. 3B) for inserting a specimen holder 31. The hollow space 18 consists of an angular milled cavity in this case. The specimen holder 31 consists of a plate (see detailed view) with a round recess 17 for inserting the specimen 3. The specimen 3 can be glued into the recess 17 of the specimen holder 31 in order to ensure that it is securely fixed in the shear plane S during the shear test. In this way, particularly short specimens can also be tested.

As in FIG. 2, the second receptacle 16 comprises a round recess 17 for inserting a cylindrical specimen 3. In this case, the adjusting device 14 only comprises one screw 141 in the second receptacle 16 in order to adjust the position of the joint 2 to be tested. The adjusting device 14 makes it possible to displace the specimen 3 relative to its receptacle 15, 16 in order to position the joint 2 of the specimen 3 exactly on the shear plane S of the two components.

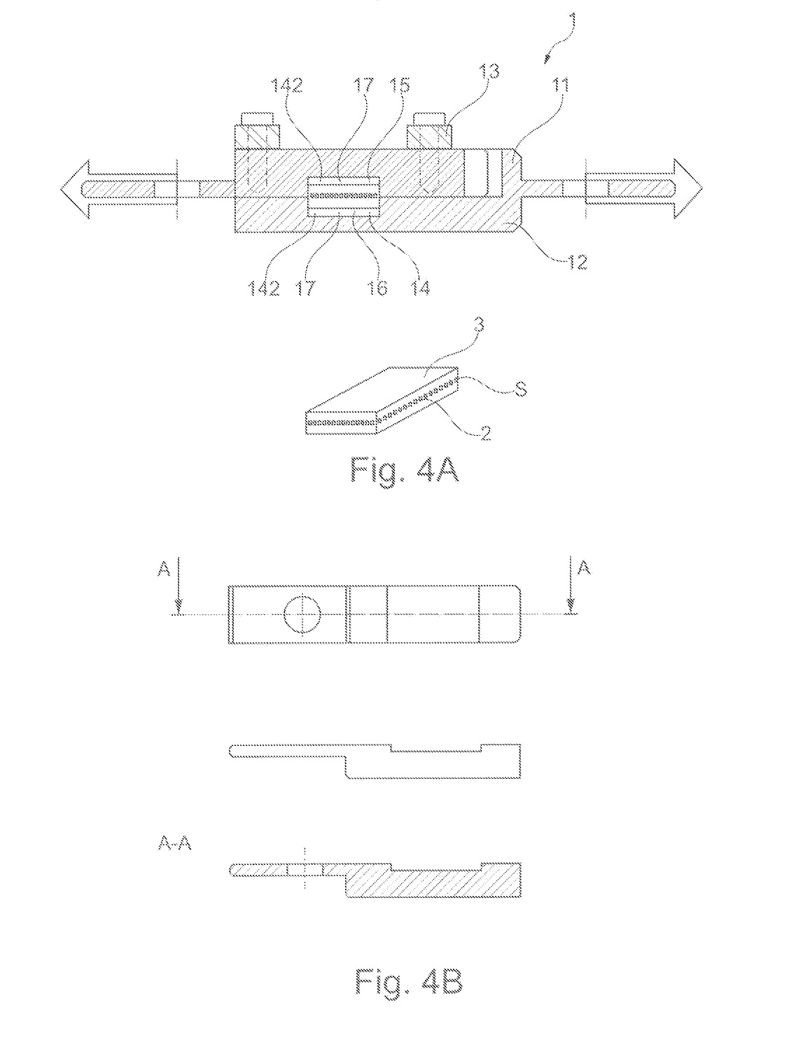

FIG. 4A shows a schematic view of the shearing device 1, and FIG. 4 shows schematic views of the first component 11 of the shearing device 1 according to another embodiment. The shearing device 1 once again comprises the first component 11, the second component 12, the fastening arrangement 13, and the adjusting device 14.

The strip-shaped and step-shaped first component 11 is illustrated in detail in FIG. 4B. The first component 11 comprises the first receptacle 15 (see, in particular, FIG. 4B), and the second component 12 comprises the second receptacle 16. The two receptacles 15, 16 respectively comprise an angular recess 17 for inserting a square or cuboid specimen 3.

In this case, the adjusting device 14 comprises two shimming means 142 for adjusting the position of the joint 2 to be tested in the first receptacle 15 and the second receptacle 16. The shimming means 142 in this case make it possible to displace the specimen 3 relative to its receptacle perpendicular to the tensioning direction in order to position the joint 2 of the specimen 3 exactly on the shear plane S of the two components 11, 12.

As a supplement, it should be noted that “comprising” does not exclude any other elements or steps, and that “a” or “an” does not exclude a plurality. It should furthermore be noted that characteristics or steps that were described with reference to one of the above exemplary embodiments can also be used in combination with other characteristics or steps of other above-described exemplary embodiments. Reference symbols in the claims should not be interpreted in a restrictive sense.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiment in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the embodiment as set forth in the appended claims and their legal equivalents.

1. A shearing device for strength testing a
joint, comprising
a first component,
a second component,
a fastening arrangement, and
an adjusting device,
wherein the first component comprises a first receptacle,
wherein the second component comprises a second receptacle,
wherein the fastening arrangement is designed for fastening the first component and the second component on one another in such a way that the first receptacle and the second receptacle face one another and a shear plane S is formed between the first component and the second component, and
wherein the adjusting device is designed for arranging a joint of a specimen to be tested in the shear plane S.

2. The shearing device of claim 1, wherein the first receptacle and/or the second receptacle comprises a round recess for inserting a cylindrical specimen.

3. The shearing device of claim 1, wherein the second receptacle and/or the first receptacle comprises a hollow space for inserting a specimen holder with a round recess for inserting the cylindrical specimen.

4. The shearing device of claim 2, wherein the recess has a diameter between 1 and 10 mm, preferably between 3 and 5 mm.

5. The shearing device of claim 1, wherein the second component comprises a cutout for receiving the first component.

6. The shearing device of claim 5, wherein the second component is blocked-shaped and the first component is step-shaped with a flat part and a thicker part, and wherein the thicker part is designed for being inserted into the cutout of the second component.

7. The shearing device of claim 1, wherein the adjusting device comprises at least one screw for adjusting the position of the joint to be tested in the first receptacle and/or the second receptacle.

8. The shearing device of claim 1, wherein the adjusting device comprises at least one shimming means for adjusting the position of the joint to be tested in the first receptacle and/or the second receptacle.

9. The shearing device of claim 1, wherein the fastening arrangement comprises at least two web-shaped strips and corresponding fastening means for connecting the strips to the second component.

10. A method for the preparation of a shearing device for strength testing a joint, comprising the following steps:
introducing a specimen with a joint to be tested into a first receptacle or into a second receptacle,
fastening a first component with the first receptacle on a second component of the second receptacle such that the first receptacle and the second receptacle face one another and a shear plane S is formed between the first component and the second component, and
arranging the joint of the specimen in the shear plane S.

11. A shearing device for strength testing a joint, comprising:
a first component comprising a first receptacle;
a second component comprising a second receptacle;
a fastening arrangement for fastening the first receptacle to the second receptacle such that they face each other;
a shear plane formed between the first receptacle and the second receptacle; and
an adjusting device for arrangement of a joint to be tested in the shear plane.

12. The shearing device of claim 1, wherein the first receptacle and/or the second receptacle comprises a round recess for inserting a cylindrical specimen therein.

13. The shearing device of claim 12, wherein the recess has a diameter between 1 and 10 mm, preferably between 3 and 5 mm.

14. The shearing device of claim 11, wherein the adjusting device comprises at least one screw for adjusting the position of the joint to be tested in the first receptacle and/or the second receptacle.

15. The shearing device of claim 11, wherein the adjusting device comprises at least one shimming means for adjusting the position of the joint to be tested in the first receptacle and/or the second receptacle.
